(19) United States
(12) Patent Application Publication
(10) Pub. No.: US 2014/0335842 A1
(43) Pub. Date: Nov. 13, 2014

(54) CUSTOMIZABLE TASK EXECUTION FLOW

(71) Applicant: Alcatel-Lucent Canada Inc., Ottawa (CA)

(72) Inventors: Katha KULASINGAM, Kanata (CA); Justin M. NEWCOMB, Kanata (CA); Kevin CUTLER, Carp (CA)

(73) Assignee: Alcatel-Lucent Canada Inc., Ottawa (CA)

(21) Appl. No.: 13/892,491

(22) Filed: May 13, 2013

(51) Int. Cl. H04W 4/00

(52) U.S. Cl. CPC H04W 4/003
USPC 455/418

(57) ABSTRACT

Various exemplary embodiments relate to a method performed by a subscriber interface node of providing a service to a subscriber. The method may include: defining a service having an execution flow comprising a plurality of predefined operations; defining a plurality of tasks, each task occurring within one of the predefined operations and comprising a service call to a role of a plug-in representing an external service provider; and executing the operations in the predefined order according to the defined tasks.

### TECHNICAL FIELD

Various exemplary embodiments disclosed herein relate generally to telecommunications.

### BACKGROUND

Telecommunications network operators often manage their own large networks of equipment and services and also provide an access point to services provided by third parties. The network operators attempt to package various services into plans and options that are appealing to a large number of customers. Managing subscriber plans can be a difficult task in a competitive business environment, especially where one or more third parties are involved in providing a service. Often, a subscriber may have to personally speak with a customer service representative in order to make a change to a service plan. The customer service representative may use various specialized systems to reconfigure the network to provide the desired plan and options. Such a framework for providing services may limit options available to subscribers for the sake of simplifying network management.

### SUMMARY

In view of the foregoing, it would be desirable to provide network operators with a system to help manage subscriber services. In particular, it would be desirable to provide a system that automatically configures new services for customers, allowing them greater flexibility.

In light of the present need for a system of managing subscriber services, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a subscriber interface node of providing a service to a subscriber. The method may include: defining a service having an execution flow comprising a plurality of predefined operations; defining a plurality of tasks, each task occurring within one of the predefined operations and comprising a service call to a role of a plug-in representing an external service provider; and executing the operations in the predefined order according to the defined tasks.

In various embodiments, the operations comprise pre-subscribe, subscribe, post-subscribe, pre-unsubscribe, unsubscribe, and post-unsubscribe. The method may further include: receiving a request, from a subscriber, to subscribe to the service; executing any tasks defined for the pre-subscribe operation; executing any tasks defined for the subscribe operation; and executing any tasks defined for the post-subscribe operation. The method may further include: receiving a request, from a subscriber, to unsubscribe from a service; executing any tasks defined for the pre-unsubscribe operation; executing any tasks defined for the unsubscribe operation; and executing any tasks defined for the post-unsubscribe operation.

In various embodiments, a plug-in implements a plurality of roles for a service provider and a set of tasks for each role, the set of tasks for each role corresponding to the plurality of predefined operations. The step of executing the operations in the predefined order may include, for each operation, calling each defined task corresponding to the operation by calling the task of the defined plug-in for the defined role.

In various embodiments, the method further includes: receiving a notification to a subscriber from a service provider; and forwarding the notification to the subscriber via a notification server.

In various embodiments, at least one of the plug-ins defines multiple roles for a single service provider.

Various exemplary embodiments relate to a subscriber interface node. The subscriber interface node may include: a notification server in communication with a communication device of the subscriber; a plurality of plug-ins, each plug-in defining an interface to a service provider comprising a set of tasks; a memory storing a plurality of services available to the subscriber, at least one service defined by an execution flow divided into a series of pre-defined operations, at least one of the pre-defined operations comprising a plurality of the tasks; and a processor configured to subscribe the subscriber to the at least one service by executing the series of pre-defined operations by calling, for each task in an operation, the associated plug-in to execute the task.

In various embodiments, the pre-defined operations include: pre-subscribe, subscribe, post-subscribe, pre-unsubscribe, unsubscribe, and post-unsubscribe. The processor may execute the pre-subscribe, subscribe, and post-subscribe operations responsive to receiving a request to subscribe to the service via the notification server. The processor may execute the pre-unsubscribe, unsubscribe, and post-unsubscribe operations responsive to receiving a request to unsubscribe to the service via the notification server.

In various embodiments, the set of tasks for at least one plug-in includes a task corresponding to each pre-defined operation, wherein the processor executes the task corresponding to the pre-defined operation when calling the plug-in for a task within the pre-defined operation.

In various embodiments, the at least one plug-in includes a set of tasks for a plurality of roles of the plug-in.

In various embodiments, the execution flow identifies a plug-in and role for each task within a pre-defined operation.

Various exemplary embodiments relate to the above described method encoded on a non-transitory machine-readable storage medium as instructions executable by a processor to perform the method.

It should be apparent that, in this manner, various exemplary embodiments enable configuration of subscriber services. In particular, by using a customizable task execution flow a subscriber interface node may interact with a plurality of network nodes or service providers for configuring a subscriber service.

### BRIEF DESCRIPTION OF THE DRAWINGS

In order to better understand various exemplary embodiments, reference is made to the accompanying drawings, wherein:

FIG. 1 illustrates an exemplary communications network;

FIG. 2 illustrates an exemplary subscriber interface node;

FIG. 3 illustrates an exemplary service profile; and

FIG. 4 illustrates a flowchart showing an exemplary method of managing subscriber services.

### DETAILED DESCRIPTION

Referring now to the drawings, in which like numerals refer to like components or steps, there are disclosed broad aspects of various exemplary embodiments.

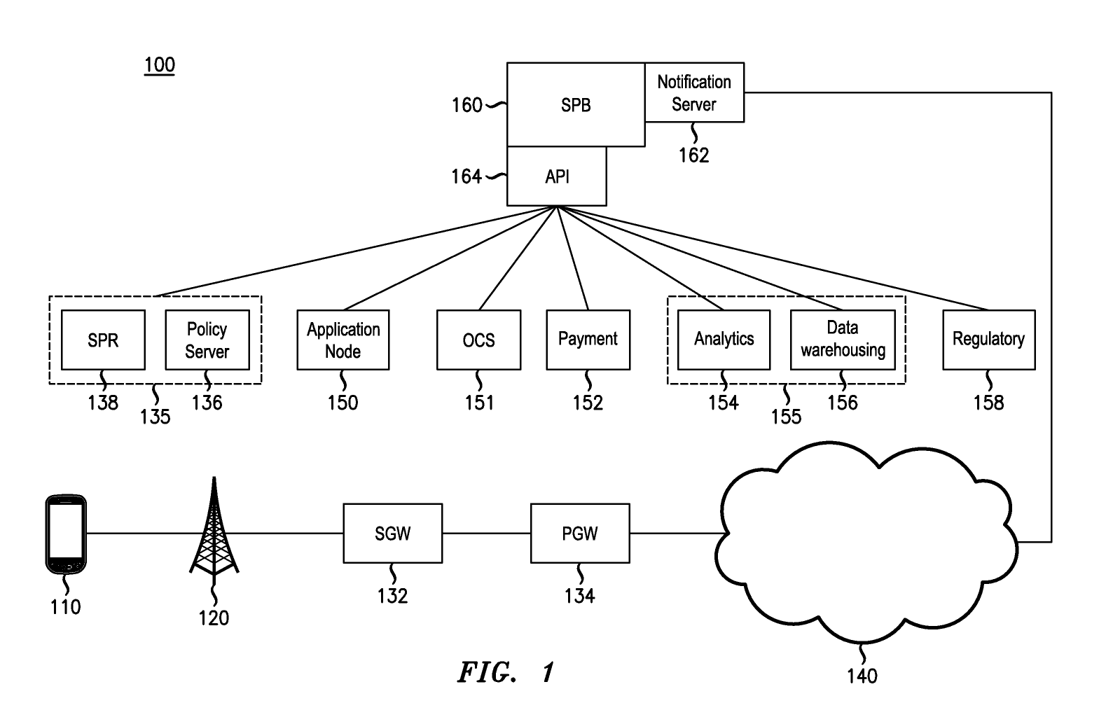

FIG. 1 illustrates an exemplary communications network 100. Exemplary communications network 100 may provide various communications services to a subscriber having a user device 110. Communications network 100 may include subscriber network components such as base station 120, serving gateway 132, packet data gateway 134, policy server 136, subscriber profile repository 138, packet data network 140, and subscriber interface node 160. Communications network 100 may also include third party services such as: application node 150, charging system 151, payment system 152, analytics service 154, data warehouse service 156, and regulatory service 158. Although FIG. 1 may illustrate a wireless communications network, the principles discussed herein may be applicable to other networks including landline and fiber networks. More specifically, subscriber interface node 160 may be used to manage subscriber services for any network having various interacting entities.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, smart phone, television set-top box, or any other device capable of communicating with other devices via network 100.

Base station 120 may be a device that enables communication between user equipment 110 and network 100. For example, base station 120 may be a base transceiver station such as an evolved nodeB (eNodeB) as defined by 3GPP standards. Thus, base station 120 may be a device that communicates with user equipment 110 via a first medium, such as radio waves, and communicates with SGW 132 via a second medium, such as Ethernet cable. Base station 120 may be in direct communication with SGW 132 or may communicate via a number of intermediate nodes (not shown). In various embodiments, multiple base stations (not shown) may be present to provide mobility to user equipment 110. Note that in various alternative embodiments, user equipment 110 may communicate directly with SGW 132. In such embodiments, base station 120 may not be present.

Serving gateway (SGW) 132 may be a device that manages data paths between the base station 120 and PGW 134. The data paths may include virtual containers called bearers with unique Quality of Service (QoS) characteristics. The bearers may include virtual connections called service data flows (SDFs). In various embodiments where user equipment 110 is a mobile device and base station 120 is an eNodeB, SGW 132 may be responsible for establishing new bearers when the mobile device changes eNodeB. In various embodiments, network 100 may include multiple serving gateways.

Packet data network gateway (PGW) 134 may be a device that provides gateway access to packet data network 140. PGW 134 may include a policy and charging enforcement function (PCEF) that enforces policy and charging control (PCC) rules for each service data flow (SDF). Thus, PGW 134 may be a policy and charging enforcement node (PCEN). PGW 134 may request new PCC rules from policy server 136. PGW 134 may also include a number of additional features such as, for example, packet filtering, deep packet inspection, and subscriber charging support.

Policy server 136 may be a device that is responsible for managing subscriber communications within network 100. In various embodiments, policy server 136 may be a policy and charging rules node (PCRN) that receives requests for application services, generates PCC rules, and provides PCC rules to the PGW 134 and/or other PCENs (not shown). Policy server 136 may be in communication with SGW 132 and PGW 134 via a Gxx and a Gx interface, respectively. In various embodiments, policy server 136 may perform an analogous function of managing subscriber communications by controlling various routers or switches providing network service to user devices.

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136 or may constitute an independent node within network 100. Data stored by SPR 138 may include an identifier of each subscriber and indications of subscription information for each subscriber such as bandwidth limits, charging parameters, subscriber priority, and subscriber service preferences. In various embodiments, SPR 138 may be the same device 135 as another network component such as policy server 136. Accordingly, a subscriber interface node 160 may have a single interface with the device 135. As will be described in further detail below, a plug-in for the device 135 may provide different roles for the device such as a role for policy server 136 and a role for SPR 138.

Packet data network 140 may be any network for providing data communications between user equipment 110 and other devices connected to packet data network 140, such as AN 150. Further, packet data network 140 may provide, for example, phone and/or Internet service to various user devices in communication with packet data network 140.

Application Node (AN) 150 may be a device that provides an application service to user device 110. Thus, AN 150 may be a server or other device that provides, for example, streaming video service to user equipment 110. AN 150 may require a subscriber to specifically subscribe to the provided service. As will be discussed in further detail below, subscriber interface node 160 may manage subscriptions to the service provided by AN 150. AN 150 may further be in communication with the PCRN 136 to provide the service to user device 110.

Charging system 151 may be an on-line or off-line charging system used by a network operator to account for subscriber usage. Charging system 151 may collect usage information for subscribers from various network components such as PGW 134. Charging system 151 may compare usage information to subscription information in order to determine appropriate billing. Charging system 151 may generate a periodic bill to a subscriber. Charging system 151 may also charge usage against prepaid plans of a subscriber.

Payment system 152 may be a financial system providing a service to transfer funds. For example, payment system 152 may be a bank, credit card system, or alternative financial system. Payment system 152 may provide funding for a subscriber to pay for the various services provided by network 100. In various embodiments, network 100 may include multiple payment systems 152.

Analytics service 154 may be a service providing statistical analysis of subscriber data. For example, analytics service 154 may analyze subscriber data to attempt to optimize a subscriber's network plans. As such, analytics service 154 may provide notifications to a subscriber indicating beneficial services. Analytics service 154 may provide marketing analysis and promotions or other features.

Data warehouse service 156 may provide storage of large amounts of data of a subscriber, network operator, or anyone else. Data warehouse service 156 may charge for storing and accessing the data. In various embodiments, data warehouse service 156 may be provided by the same service provider 155 as another component such as, for example analytics service 154. As will be described in further detail below, a service provider 155 offering more than one service may provide a plug-in defining multiple roles of the service provider.

Regulatory service 158 may be a government entity or other group that monitors for compliance with government or other regulations. For example, regulatory service 158 may provide an interface for reporting information to an oversight agency such as the federal communications commission (FCC). Regulatory service 158 may also provide an interface for lawful intercept of subscriber information, for example, through the use of digital subpoenas.

Subscriber interface node 160 may be a device providing coordination of communications involving a subscriber among the various components of exemplary network 100. As will be described in further detail below, subscriber interface node 160 may be configured to interface with a variety of different network components using plug-ins. The plug-ins may provide an application programming interface (API) 164 for interacting with network components or use an API provided by the network component. A network operator may configure subscriber interface node 160 with various services that may be offered to subscribers. Subscriber interface node 160 may include a notification server 162 configured to interact with subscribers through an application on the user device 110. The notification server 162 may allow subscribers to subscribe to and unsubscribe from various services offered by a network operator. The notification server 162 may also push notifications or other messages to a subscriber.

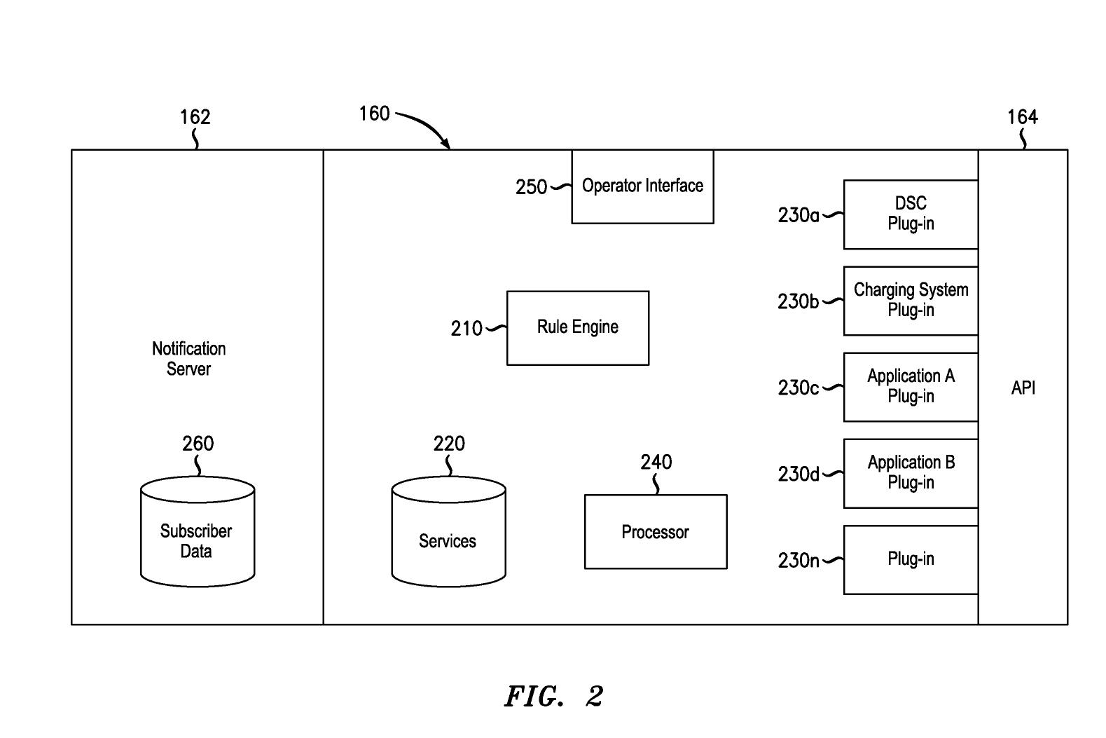

FIG. 2 illustrates an exemplary subscriber interface node 160. Subscriber interface node 160 may include notification server 162. In various embodiments, notification server 162 may be a separate device. Subscriber interface node 160 may also include rules engine 210, service information storage 220, a plurality of plug-ins 230, processor 240, and operator interface 250.

Notification server 162 may provide for communications with a subscriber's user device. In various embodiments, notification server 162 may communicate with an application running on a subscriber device 110. The notification server 162 may maintain an open communication session between the subscriber interface node 160 and each user device 110. In various exemplary embodiments, the notification server 162 may use a network data connection provided by the network operator to provide the communication session. The notification server may provide a notification address for each subscriber and translate various subscriber identifiers used throughout network 100 to the correct notification address. For example, notification server 162 may receive a notification including a subscriber identifier for an account at an application server and translate that identifier to a notification address of the subscriber. Notification server 162 may store notification addresses and other relevant data in subscriber data storage 260. In various embodiments, notification server 162 may use additional forms of communication such as e-mail, text messages, and voice or video calls.

Rules engine 210 may include hardware or instructions encoded on a machine-readable storage medium configured to make operating decisions for subscriber interface node 160. Rules engine 210 may receive messages from a user device 110 via the notification server 162 and messages from network components via plug-ins 230. Rules engine 210 may use rules including criteria and results to evaluate received messages and determine appropriate actions based on the messages. In various embodiments, actions may include executing an execution flow as defined for a particular service.

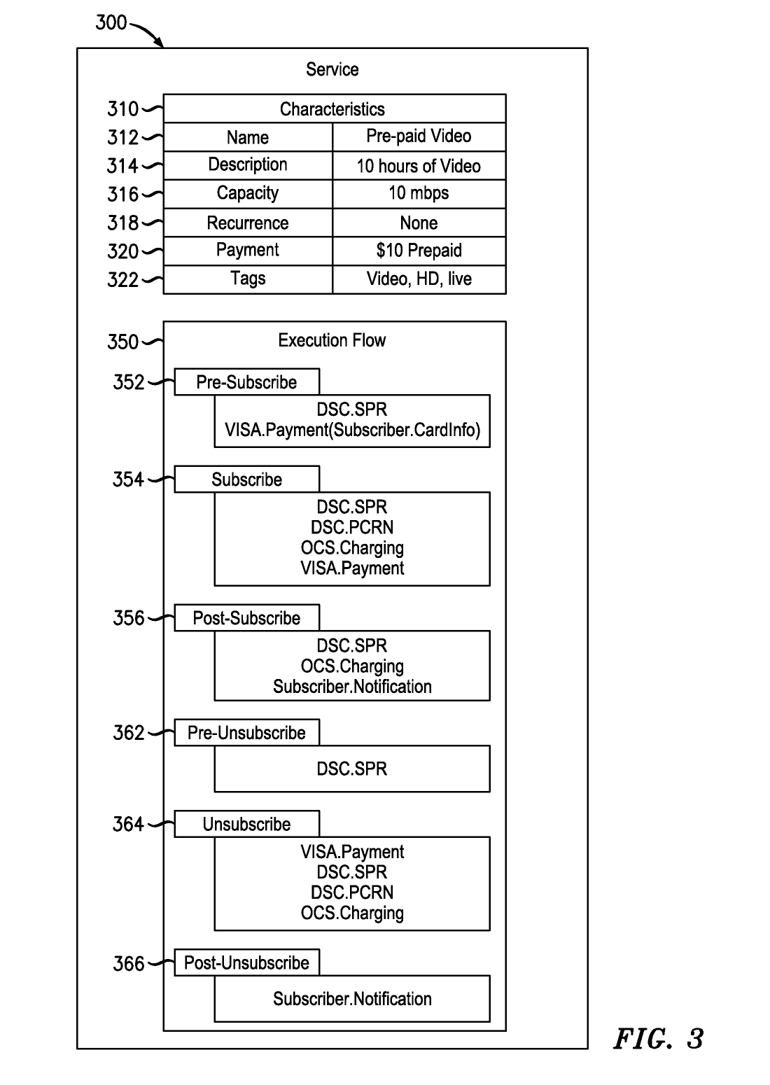

Services storage 220 may be a computer-readable storage medium configured to maintain records for services offered by a network operator to which a subscriber may subscribe. As will be discussed in further detail below regarding FIG. 3, a record in services storage 220 may store information about the service as well as an execution flow controlling configuration of the service for a subscriber. A plug-in 230 may also declare service-specific information to be defined in the service record. The execution flow may be performed by processor 240 when a subscriber requests to subscribe or unsubscribe from the service. The execution flow may include calls to tasks performed by plug-ins 230.

Plug-ins 230 may be software modules encoded on a machine-readable storage medium as instructions executable by a processor 240. Each plug-in 230 may be specific to an individual network component such as a server. Multiple instances of a plug-in may be used if the network 100 includes multiple similar network components, such as, for example, multiple payment systems or redundant databases.

A plug-in 230 may be provided by either the network operator or a third party service provider. For example, a network operator may create a plug-in to interface with legacy components. Such a plug-in 230 may use an API of the legacy component to define tasks corresponding to the operations of the subscriber interface node 160. The subscriber interface node 160 may provide generic plug-ins for known device types that may be customized for individual components within the network. On the other hand, a third party service provider, such as an application node 150, may provide a plug-in 230 for a particular application. The plug-in 230 may use an API provided by the subscriber interface node 160. For example, the plug-in may call functions provided by the API to obtain information required by the application node 150. The API may provide access to information regarding specific services and subscribers. The function calls may be embedded within the tasks of the plug-in and executed by the processor 240 of subscriber interface node 160 when a corresponding operation is executed.

Processor 240 may be a computer processor configured to execute instructions stored on a machine-readable storage medium. For example, processor 240 may execute instructions provided by plug-ins 230.

Operator interface 250 may include hardware and/or executable instructions on a machine-readable storage medium configured to allow a network operator to configure subscriber interface node 160. The operator interface 250 may provide the operator with options for importing, installing, and removing plug-ins 230. The operator interface 250 may also provide an editor for editing the service records stored in services storage 220. The operator interface 250 may provide a list of available plug-ins 230 and respective tasks that may be used in an execution flow.

FIG. 3 illustrates an exemplary service profile 300. Exemplary service profile 300 may be a service profile configured for a service offered by a network operator. As one example, the service profile 300 may provide a prepaid video service entitling a subscriber to ten hours of video from a particular application. The service may bundle the network costs of transmitting the data with the application costs for the content. The service may be advertised to subscribers via notification server 160, and subscribers may choose to subscribe to the service. The service profile 300 may include service characteristics 310 and execution flow 350.

Service characteristics 310 may include any information available about the specific service. For example, service characteristics 310 may include a name 312, description 314, capacity 316, recurrence 318, payment 320, and tags 322. The name 312 may indicate a name of the service used by the subscriber interface node 160 to identify the service to subscribers. For example, the service may have the name “Pre-Paid Video.” Description 314 may include a textual description of the service. For example, the Pre-Paid Video service may be described as ten hours of video from a particular video provider. Capacity 316 may define resources required by the service. For example, the pre-paid video service may require 10 mbps downlink capacity. Recurrence 318 may define how often a subscription to the service is renewed. For example, the pre-paid video service may not have any recurrence. As other examples, a service may have an annual, monthly, weekly, or daily recurrence. An operation and tasks may be defined that may execute when a service recurs. Payment 320 may define a cost of the service. The amount of the payment 320 may be charged to a subscriber's account or payment method depending on the execution flow. Tags 322 may define words that have been used to tag the service. Tags 322 may be searched by the subscriber application to find services that may be of interest to the subscriber. Some of the service characteristics 310 may be declared by plug-ins 230. For example, the plug-in 230 for application node 150 may define the required capacity 316.

Execution flow 350 may define operations that may be performed by the subscriber interface node 160 to configure a service for a provider. In various exemplary embodiments, the operations may include pre-subscribe 352, subscribe 354, post-subscribe 356, pre-unsubscribe 362, unsubscribe 364, and post-unsubscribe 366. The operations may be simplified or arranged in a hierarchical manner. For example, the operations may be reduced to subscribe and unsubscribe and/or include sub-operations. The subscriber interface node may define additional operations that may be implemented by plug-ins and included within an execution flow. For example, a recurrence operation may be defined by the subscriber interface node and implemented by a payment plug-in 230 for processing recurring payments.

The execution flow 350 may include tasks within each operation. A task may identify a plug-in and a role to be performed by the plug in. When a task is executed, the plug-in may perform a task corresponding to the operation for the role.

Having described the various components of exemplary network 100 including subscriber interface node 160, a brief description of configuration based on exemplary service record 300, as shown in FIG. 3, will be described to illustrate a use of customizable execution flows with the subscriber interface node 160. A network operator may configure customizable execution flows 350 to perform various operations for services.

As shown in the example of a pre-paid video service in FIG. 3, the pre-subscribe operation 352 of exemplary service record 300 may include an SPR task and a Payment task. The SPR task may identify the DSC plug-in 230a and the SPR role. When the pre-subscribe operation is executed, the processor 240 may call the DSC plug-in 230a to execute the pre-subscribe operation in the SPR role. The pre-subscribe operation may be defined by the individual plug-in. For example, a pre-subscribe operation for an SPR role may query the SPR for subscriber information and determine whether the subscriber's current plan allows for the addition of the new service. As a second example, the Payment task may identify a VISA plug-in and a payment role. The Payment task may also include a parameter providing card information entered by the subscriber. As an example, a pre-subscribe task for a payment operation may preauthorize a transaction by determining whether an account holds sufficient funds or has available credit for the transaction.

The subscribe operation 354 may include the tasks: DSC.SPR, DSC.PCRN, OCS.Charging, and VISA.Payment. The DSC.SPR subscribe task may update the SPR record for the subscriber to indicate that the subscriber is subscribed to the new service. The DSC.PCRN subscribe task may inform the PCRN 136 of any new policies that need to be implemented to provide the new service to the subscriber. It may be noted that both the DSC.SPR and DSC.PCRN tasks place calls to the DSC plug-in, which may be associated with device 135. The DSC plug-in 230a may perform different tasks based on the identified roles of SPR and PCRN, respectively. The DSC.SPR task in subscribe operation 354 may appear similar to the DSC.SPR task in pre-subscribe operation 352; however, the tasks may depend on the operation calling the task. Accordingly, the DSC plug-in may perform both a pre-subscribe task and a different subscribe task when called. The OCS.Charging task may update the charging system to indicate the new service such that the charging system may charge usage of the new service appropriately against the pre-paid quota, in this example. The VISA.Payment task may submit or settle the pre-authorized transaction. Accordingly, the network operator may receive payment for providing the new service.

The post-subscribe operation 356 may include the tasks: DSC.SPR, OCS.Charging, and Subscriber.Notification. The DSC.SPR task may confirm that the subscriber record has been correctly updated. The OCS.Charging task may install reporting rules at the charging node to push usage notifications to the subscriber. The Subscriber.Notification task may send a notification to the subscriber's user device 110 indicating that the service was successfully added. The Subscriber.Notification task may be performed by the notification server 162 rather than a plug-in 230. The subscriber notification may also occur as a result of the rules engine 210 determining that the subscribe request was successful rather than as a task within an execution flow. Such a result of the rules engine may not be configurable.

The pre-unsubscribe operation 362 may include the DSC.SPR task. The DSC.SPR task may confirm that the subscriber is currently subscribed to the service. In various embodiments, confirming the subscriber's subscription may be performed automatically rather than as part of the customizable execution flow.

The unsubscribe operation 364 may include the VISA.Payment, DSC.SPR, DSC.PCRN, and OCS.Charging tasks. The VISA.Payment task may refund a portion of the payment for the service. The DSC.SPR task may update the subscriber information to indicate that the service is no longer subscribed. The DSC.PCRN task may remove any rules from the policy server 136 for providing the service. The OCS.Charging task may remove any current balance or quota specifically for the service.

The post-unsubscribe operation 366 may include a subscriber.notification task. The subscriber.notification task may push a message to the subscriber indicating the subscriber has successfully been unsubscribed from the service. As discussed above, the subscriber notification may occur through the notification server 162 and may use a result of rules engine 210 rather than a task in the execution flow.

In view of the foregoing, the subscribe and unsubscribe operations may be used to configure a service for a subscriber. The foregoing description is meant to highlight some possible tasks performed by the plug-ins 230. Service providers may provide plug-ins providing additional tasks that may be included within an execution flow. Network operators may configure the execution flow for individual services based on the configuration needs of the particular service.

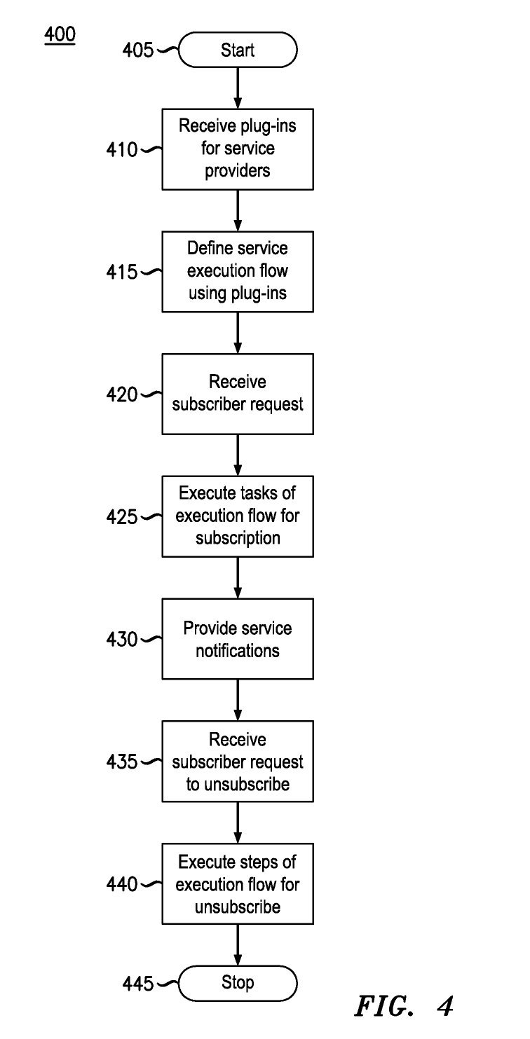

FIG. 4 illustrates a flowchart showing an exemplary method 400 of managing a subscriber service. The method 400 may be performed by a subscriber interface node 160. The method 400 may begin at step 405 and proceed to step 410.

In step 410, the subscriber interface node 160 may receive plug-ins for service providers operating network components. The plug-ins may be received via a specialized configuration interface that allows loading and management of plug-ins. Once the subscriber interface node 160 receives the plug-ins, the tasks for the plug-ins may become available to be called by a service execution flow.

In step 415 a network operator may configure a service profile 300 including a service execution flow 350. The network operator may use operator interface 250 to define tasks for one or more operations. The network operator may select tasks to perform from a list of tasks provided by the plug-ins. A service execution flow 350 may not require tasks for every operation. For example, a service may be configured without any post-subscribe operations. In various embodiments, an operator may use a service execution flow for more than one service. For example, two similar services offered by the same service provider or competing third parties may be configured in a similar manner and only service characteristics for the services may differ. Even though the service execution flow may be the same, it may configure a different service based on the different service characteristics. Similarly, the execution flow for new services may be modeled after existing services. Accordingly, a less experienced operator may be able to more easily configure a service.

In step 420, the subscriber interface node 160 may receive a request from a subscriber to subscribe to a service. The subscriber may send the request via a subscriber application executed on the user device 110 that communicates with the notification server 162. The request may include an identification of the requested service as well as subscriber information, such as, for example, payment information.

In step 425, the subscriber interface node 160 may execute the tasks of the execution flow for the subscribe operations in order: pre-subscribe, subscribe, and post-subscribe. Within each operation, the tasks may be performed in the order defined by the execution flow. Alternatively, the subscriber interface node 160 may be able to perform a plurality of tasks simultaneously by calling different plug-ins. In such embodiments, the organization into pre-subscribe, subscribe, and post-subscribe operations may be sufficient to ensure that the tasks occur in the correct order.

In step 430, the subscriber interface node 160 may provide notifications regarding the service. The subscriber interface node 160 may receive notifications from any of the network components via the plug-ins 230. The subscriber interface node 160 may push notification messages to the subscriber's user device 110 via the notification server 162. The notification messages may provide information such as current usage, remaining balance, renewal reminders, service updates and any other information a service provider may want to provide to subscribers of the service.

In step 435, the subscriber interface node 160 may receive a request from a subscriber to unsubscribe from a service. The subscriber may send the request via a subscriber application executed on the user device 110 that communicates with the notification server 162. The request may include an identification of the service. A request to unsubscribe may also be received automatically from, for example, a SPR 138 or policy server 136 in response to another change in the subscriber policy such as, for example, dropping a line, data plan, or other required supporting service.

In step 440, the subscriber interface node 160 may execute the tasks of the execution flow for the unsubscribe operations in order: pre-unsubscribe, unsubscribe, and post-unsubscribe. Within each operation, the tasks may be performed in the order defined by the execution flow. Alternatively, the subscriber interface node 160 may be able to perform a plurality of tasks simultaneously by calling different plug-ins. Once the execution flow has completed, the method 400 may proceed to step 445, where the method may end.

According to the foregoing, various exemplary embodiments provide for configuration of subscriber services. In particular, by using a customizable task execution flow a subscriber interface node may interact with a plurality of network nodes or service providers for configuring a subscriber service.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method performed by a subscriber interface node of providing a service to a subscriber, the method comprising:
defining a service having an execution flow comprising a plurality of predefined operations;
defining a plurality of tasks, each task occurring within one of the predefined operations and comprising a service call to a role of a plug-in representing an external service provider; and
executing the operations in the predefined order according to the defined tasks.

2. The method of claim 1, wherein the operations comprise pre-subscribe, subscribe, post-subscribe, pre-unsubscribe, unsubscribe, and post-unsubscribe.

3. The method of claim 2, further comprising:
receiving a request, from a subscriber, to subscribe to the service;
executing any tasks defined for the pre-subscribe operation;
executing any tasks defined for the subscribe operation; and
executing any tasks defined for the post-subscribe operation.

4. The method of claim 3, further comprising:
receiving a request, from a subscriber, to unsubscribe from a service;
executing any tasks defined for the pre-unsubscribe operation;
executing any tasks defined for the unsubscribe operation; and
executing any tasks defined for the post-unsubscribe operation.

5. The method of claim 1, wherein a plug-in implements a plurality of roles for a service provider and a set of tasks for each role, the set of tasks for each role corresponding to the plurality of predefined operations.

6. The method of claim 5, wherein the step of executing the operations in the predefined order comprises for each operation, calling each defined task corresponding to the operation by calling the task of the defined plug-in for the defined role.

7. The method of claim 1, further comprising:
receiving a notification to a subscriber from a service provider via a plug-in; and
forwarding the notification to the subscriber via a notification server.

8. The method of claim 1, wherein at least one of the plug-ins implements multiple roles for a single service provider.

9. A subscriber interface node comprising:
a notification server in communication with a communication device of the subscriber;
a plurality of plug-ins, each plug-in defining an interface to a service provider comprising a set of tasks;
a memory storing a plurality of services available to the subscriber, at least one service defined by an execution flow divided into a series of pre-defined operations, at least one of the pre-defined operations comprising a plurality of the tasks;
a processor configured to subscribe the subscriber to the at least one service by executing the series of pre-defined operations by calling, for each task in an operation, the associated plug-in to execute the task.

10. The subscriber interface node of claim 9, wherein the pre-defined operations comprise pre-subscribe, subscribe, post-subscribe, pre-unsubscribe, unsubscribe, and post-unsubscribe.

11. The subscriber interface node of claim 10 wherein the processor executes the pre-subscribe, subscribe, and post-subscribe operations responsive to receiving a request to subscribe to the service via the notification server.

12. The subscriber interface node of claim 10, wherein the processor executes the pre-unsubscribe, unsubscribe, and post-unsubscribe operations responsive to receiving a request to unsubscribe to the service via the notification server.

13. The subscriber interface node of claim 9, wherein the set of tasks for at least one plug-in comprises a task corresponding to each pre-defined operation, wherein the processor executes the task corresponding to the pre-defined operation when calling the plug-in for a task within the pre-defined operation.

14. The subscriber interface node of claim 9, wherein at least one plug-in comprises a set of tasks for a plurality of roles of the plug-in.

15. The subscriber interface node of claim 9, wherein the execution flow identifies a plug-in and role for each task within a pre-defined operation.

16. A non-transitory computer-readable storage medium encoded with instructions executable by a processor, the non-transitory computer readable storage medium comprising:
instructions for defining a service having an execution flow comprising a plurality of predefined operations;
instructions for defining a plurality of tasks, each task occurring within one of the predefined operations and comprising a service call to a role of a plug-in representing an external service provider; and
instructions for executing the operations in the predefined order according to the defined tasks.

17. The non-transitory computer-readable storage medium of claim 16, wherein a plug-in implements a plurality of roles for a service provider and a set of tasks for each role, the set of tasks for each role corresponding to the plurality of predefined operations.

18. The non-transitory computer-readable storage medium of claim 17, wherein the instructions for executing the operations in the predefined order comprises for each operation, calling each defined task corresponding to the operation for the defined plug-in for the defined role.

19. The non-transitory computer-readable storage medium of claim 16, further comprising:
instructions for receiving a notification to a subscriber from a service provider via a plug-in; and
instructions for forwarding the notification to the subscriber via a notification server.

20. The non-transitory computer-readable storage medium of claim 16, wherein at least one of the plug-ins defines multiple roles for a single service provider.
